(19) United States
(12) Patent Application Publication
(10) Pub. No.: US 2020/0128353 A1
(43) Pub. Date: Apr. 23, 2020

(54) Smart Mooring Beacon Reservation System and Related Methods

(71) Applicant: Susan Waldrop, Vineyard Haven, MA (US)

(72) Inventor: Susan Waldrop, Vineyard Haven, MA (US)

(21) Appl. No.: 16/167,965

(22) Filed: Oct. 23, 2018

(51) Int. Cl. H04W 4/021; B63B 21/00; G06Q 10/02; E02B 3/24; F21V 23/04

(52) U.S. Cl. CPC H04W 4/021; B63B 21/00; B63B 2021/003; E02B 3/24; F21V 23/0435; G06Q 10/02

(57) ABSTRACT

A method of reserving a mooring beacon includes activating an application programming interface in communication with a database of mooring sites; transmitting a wireless signal from the application programming interface to a first mooring site within the database of mooring sites; selecting the mooring beacon from the first mooring site; receiving a location and availability of the mooring beacon; and reserving the mooring beacon for a desired reservation time. The mooring beacon is attached to each mooring site for purposes of instantaneous confirmation of availability and location. Safety, navigation ease, local weather and drop off and pick up data are also permitted by the mooring beacon enabling the owner to work toward full capacity mooring use.

### FIELD OF THE DISCLOSURE

The present invention relates to moorings and more particularly is related to a mooring reservation system.

### BACKGROUND OF THE DISCLOSURE

It will be appreciated that sailing vessels such as sailboats and motorboats require a mooring or boat slip to attach to when coming into port. Leaving a mooring is not an issue, but finding a mooring again or finding a guest mooring at the end of a boating event is oftentimes problematic. Moorings may be marked by color, number or by other indicia. However, regardless of how the mooring is marked, it may not be viewable from a distance or may be obscured by fog or other boats in the area.

In broad daylight, even experienced sailors or boaters who have identified their mooring location before departure can find it difficult to find the mooring after a race. For example, the indicia may be rotated away from view, or other boats may have moved, or the line-up with a land marker may have shifted. The problem of locating a mooring happens in a field as small as about 30 moorings. Add to this basic dilemma a heavy breeze, a few extra boats all searching for their mooring, particularly as they all come in after a race, a larger more crowded mooring field, and there could be collisions from boats tacking in close quarters, all trying to find their moorings.

For instance, in Marblehead Harbor alone there are about 2600 moorings, with the boats moored side-by-side with very little maneuvering room. When coming into the harbor it is oftentimes not possible to even see the mooring for which one is headed and certainly not to be able to identify it at any distance. This is even further complicated by fog or in driving rain such that it is oftentimes impossible to locate the correct mooring buoy. In such a situation ordinarily, a boat has to circle the mooring field a number of times in order to be able to identify the correct mooring.

It is even harder to coordinate moorings for transient harbor visitors. Moorings do not have practical means of indicating if it has been booked for future use. Transient harbor visitors, miles away, do not have a practical way of knowing if a mooring is being used, knowing how long the mooring will be in use, and reserving a specific mooring in advance for future use. There are reservations systems but they currently require the local harbormaster or marina to confirm or deny reservations made by a supercomputer system. If the harbormaster or marina owner is not near his/her computer, the reservation confirmation may lag for some time—a few hours to several days. In addition there may be overbooking because computers are not talking to each other. Finally, mooring ball location is not shown on a smart phone application and moving moorings from time to time as needed can be problematic for easy location by the infrequently visiting customer. Further, there is an opportunity for mooring sharing and yacht sharing with the proper infrastructure, which is not currently in place.

It is therefore important to provide a mooring beacon that can be reserved remotely and located easily upon arrival.

### SUMMARY OF THE DISCLOSURE

Embodiments of the present disclosure provide a system and method for reserving a mooring stick or mooring beacon (herein, “mooring beacon” is defined as a mooring stick with the capacity to output a signal visually, audially, and/or through a wireless communication signal). One embodiment of such a method, among others, can be broadly summarized by the following steps: activating an application programming interface in communication with a database of mooring sites; transmitting a wireless signal from the application programming interface to a first mooring site within the database of mooring sites; selecting the mooring beacon from the first mooring site; receiving a location and availability of the mooring beacon; and reserving the mooring beacon for a desired reservation time.

The present disclosure may also be viewed as providing methods of reservation. In this regard, one embodiment of such a method, among others, can be broadly summarized by the following steps: communicating, by an application management interface, with a plurality of mooring sites in wireless communication via a network; and selecting a mooring beacon, through the wireless communication with the mooring site.

The present disclosure can also be viewed as a mooring beacon reservation system. Briefly described, in architecture, one embodiment of the system, among others, can be implemented as follows. The mooring beacon reservation system having a mobile platform. A mooring site includes a housing structure located on a dock for a local harbormaster or other management of the mooring site. A reservation management computer at the mooring site and connected to a wireless network, where the reservation management computer is in communication with the mobile platform via the wireless network. The reservation management computer having a processor and a non-transitory computer-readable memory. The reservation management computer having a first transmitter that communicates with a first receiver of the mooring beacon to receive the mooring beacon's location and availability.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is flow chart of the mooring beacon reservation method.

FIG. 2 is a block diagram of the mooring beacon reservation method of FIG. 1, in accordance with the first exemplary embodiment of the present disclosure.

FIG. 3 is a block diagram of the mooring beacon reservation method of FIG. 1 with near-field wireless communication between the reservation management computer and the mooring beacon, in accordance with the first exemplary embodiment of the present disclosure.

FIG. 4 is a flow chart of the mooring beacon reservation method of FIG. 1, in accordance with the first exemplary embodiment of the present disclosure.

FIG. 5A-5C are screenshots that illustrate the reservation management interface application on a mobile platform, in accordance with the first exemplary embodiment of the present disclosure.

FIG. 6 is a perspective view of the mooring beacon device of the mooring beacon reservation method of FIG. 1, in accordance with the first exemplary embodiment of the present disclosure.

FIG. 7 is a flow chart of the mooring beacon reservation method of FIG. 1, in accordance with the first exemplary embodiment of the present disclosure.

### DETAILED DESCRIPTION

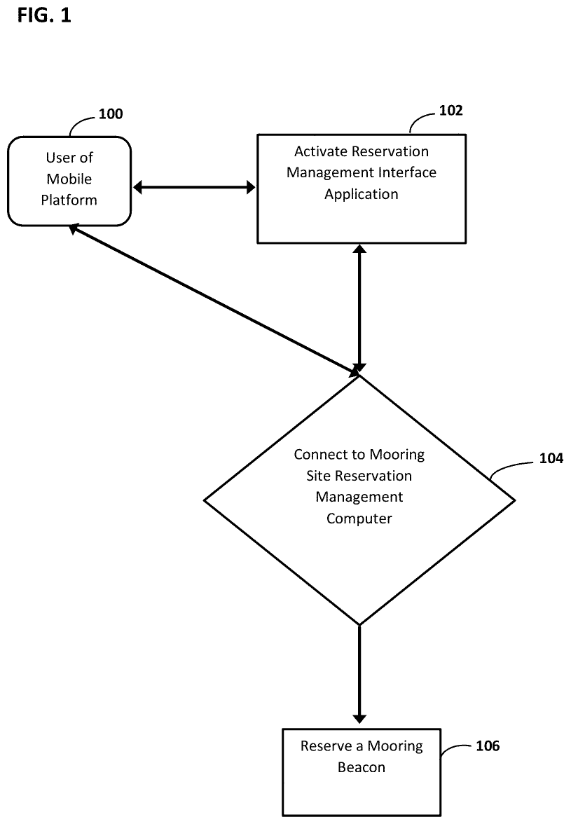

FIG. 1 is a flow chart of the mooring beacon reservation method. A user on a mobile platform 100 runs a reservation management interface application 102. The reservation management interface application 102 may contain a listing of mooring sites and the user 100 may select a mooring site for connection. After selection, the user's reservation interface application 102 is configured to wirelessly connect to the reservation management computer that may be housed in the mooring site 104 and operated locally by a harbormaster. The reservation management computer 104 may be configured to contain a database of mooring beacons that are assigned to the mooring site. The reservation management computer 104 can enable the user to reserve a mooring beacon 106 for an allotted date and time. The reservation management computer 104 may include or use a transmitter to send a signal to a receiver integral the mooring beacon 106 so that the user can activate the mooring beacon 106, as will be described further herein. The mobile platform used can be any mobile device that is cable of running applications. The wireless communication between the reservation management computer 104 and the mooring beacon 106 may utilize any wireless communication system known in the art, such as, but not limited to, satellite, infrared, broadcast radio, radio, Wi-Fi, mobile, and Bluetooth. Further, the reservation management computer 104 may support direct communication with the mobile platform 100.

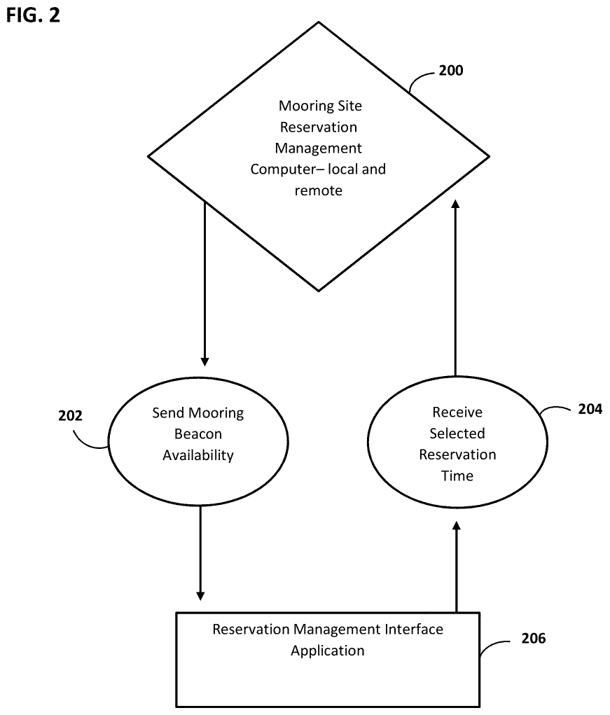

FIG. 2 is an illustration of the reservation management computer 200 communicating with the reservation management interface 206 to reserve a mooring beacon. The mooring site's reservation management computer 200 contains a database of the mooring beacons assigned to the mooring site 200 and wirelessly sends the mooring beacon availability 202 to the reservation management interface application 206. The user may choose a mooring beacon and desired length of reservation 204. The reservation management interface application 206 sends the desired reservation length 204 to the reservation management computer 200. The reservation management computer may send a confirmation message to the reservation management interface application 206 to finalize the mooring beacon reservation. Therein, the confirmation message may give the user an option to cancel the previously booked reservation. The mooring beacon availability 202 may be in the form of a calendar that shows which days and times are already reserved and what days and times are available. The mooring beacon availability may require a selected reservation time 204 to be a minimum of one hour and a maximum of 504 hours.

As illustrated in FIG. 2, the reservation management computer 200 may be local to the harbor. The reservation management interface application 206 may be remotely located from both the harbor and the user. More specifically, reservation management interface application 206 may be located on a remote server. The user may obtain a reservation by using a computer or mobile device to access the reservation management interface application 206, which coordinates with the reservation management computer 200. Alternatively, the user may call a harbormaster local to the reservation management computer 200 who may input the reservation into the reservation management computer 200, which then communicates with the reservation management interface application 206 to confirm the reservation.

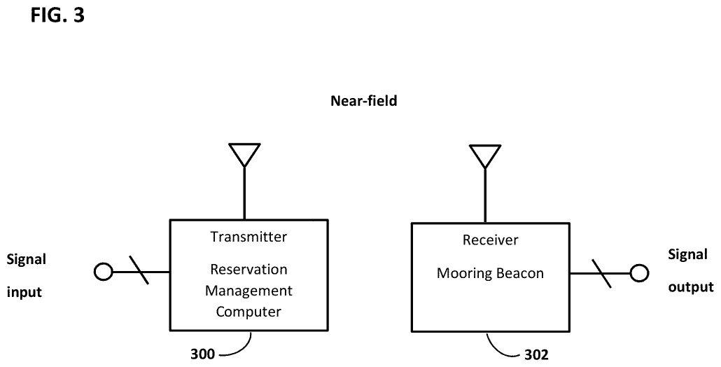

FIG. 3 is an illustration of the wireless communication of the reservation management computer 300 and the mooring beacon 302. The receiver of the mooring beacon 302 outputs a signal that is received by the transmitter of the reservation management computer 300. The transmitter 300 and receiver 302 may be at a near field communication distance (up to 35 cm).

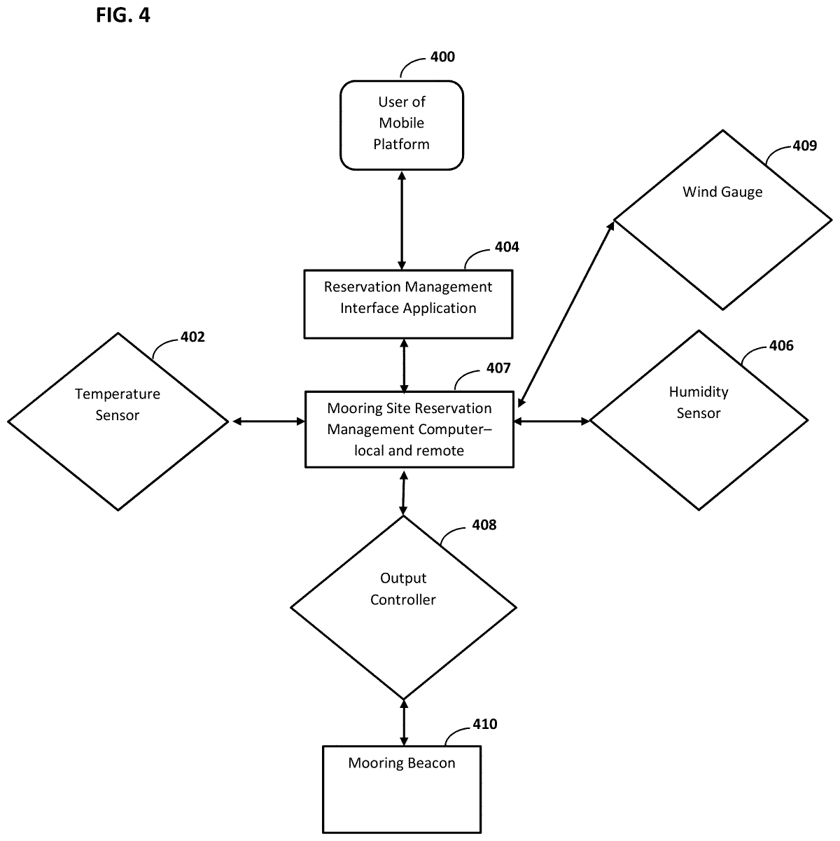

FIG. 4 is an illustration of the reservation management interface application 404 communicating with the mooring beacon 410 through the mooring site reservation management computer 407 and other features of the reservation management interface application 404. The mooring beacon 410 includes an output device, which may include an optic output device or an audial output device. A user of a mobile platform 400 may access the reservation management interface application 404 and the reservation management interface application 404 may communicate with the mooring site reservation management computer 407, which may contain a built in output controller 408 that alters a magnitude or intensity of output from the output device integral with the mooring beacon 410. Alternatively, the reservation management interface application 404 may contain the built-in output controller 408 and communicate through the mooring site reservation management computer 407. The output controller 408 may communicate through the transmitter illustrated in FIG. 3. In addition, the mooring site reservation management computer 407 may contain built-in a temperature sensor 402, a wind gauge 409, and a humidity sensor 406. In another embodiment, a GPS locator may be in the mooring beacon 410 and the reservation management interface application 404 may access weather information (including wind speed) based off the GPS locator. If the output device includes an optic output device, specifically a light source, the user 400 may alter illumination of the light source via the output controller 408. The output controller 408 may be used to alter light intensity to turn off the light source or for a user to identify the light source from a quarter mile, half a mile, three quarters of a mile, one mile, or a greater distance away.

A user 400 can use the output controller 408 to identify the reserved mooring beacon 410 amongst other mooring beacons. The output controller 408 can have a pattern feature that establishes an output pattern from the output device. The pattern feature may include repeated turning the output device on and off. If the output device is a light source, the user 400 may choose different variations of colors. The pattern feature may also alternate colors in a selected color pattern. In certain embodiments, the pattern feature may be configured in a pattern that displays images or imitates the appearance of a lighthouse. The pattern feature may be used when a user 400 is within a quarter mile from the reserved mooring beacon 410. The output controller 408 may also have an audial pattern which is configured to release a beeping or other repeated sound from the mooring beacon 410 if a user 400 has further trouble finding the reserved mooring beacon 410. The pattern feature may be accessible when the reservation time has already begun so that the user 400 must have an active reservation to activate the pattern feature. In certain embodiments, the output controller 408 may have a multi-color LED strobe light feature. The user 400 can use the output controller 408 to select the flash energy, discharge time, and color of the reserved mooring beacon light for identification. The user 400 may also be able to alter colors or sounds from the output device concurrent with use of a mobile device and without any pattern.

The temperature sensor 402 and humidity sensor 406 may have Bluetooth or Wifi connectivity within a −40° F. to 140° F. temperature range and a temperature accuracy of ±1.3° F.

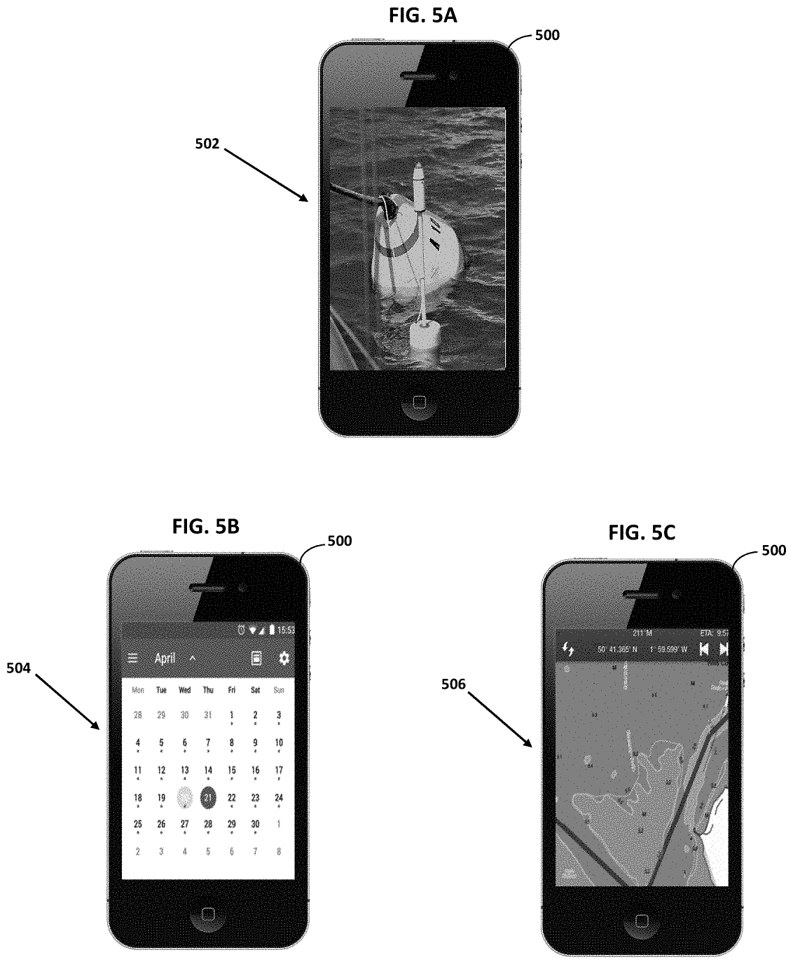

FIG. 5A-5C are illustrations of variations of the reservation management interface application 102 (FIG. 1) on a mobile touch screen device 500. A user may select a picture of the desired mooring beacon 502 and see the availability of the mooring beacon 502 via a mobile interactive calendar 504. Once a reservation is made by selecting the date on the calendar 504, the user may receive GPS navigation 506 to the pin-point location of the mooring beacon 502.

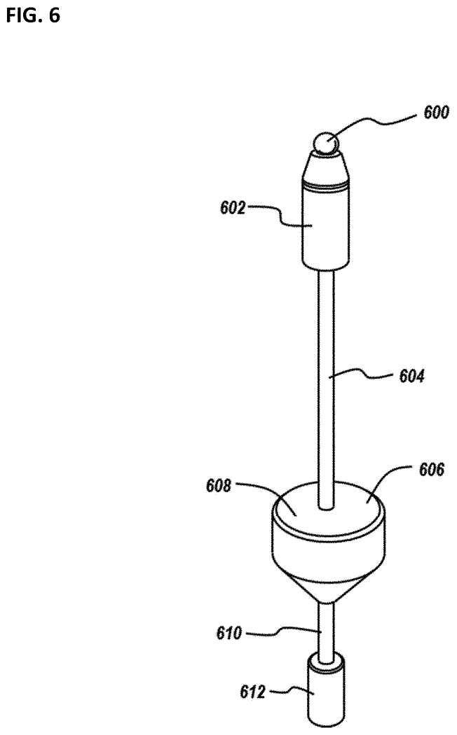

FIG. 6 is an illustration of a perspective view of a mooring beacon. The mooring beacon 606 is comprised of a shaft 604 that extends through a float 608 in and carries a receiver unit 602 adapted to receive wireless signals. This signal may be coded such that the only mooring beacon 606 that has its high-power light source activated is the one that corresponds in code or frequency to the transponder actuated. On top of the receiver housing is a high intensity omnidirectional light source 600 which is visible at large distances due to the high intensity of the light source 600, be it a strobe light in one embodiment or a plurality of LEDs aimed around the compass points to provide 360° coverage. The bottom portion 610 of the shaft 604 is provided with a battery package 612 which powers the mooring beacon 606 but also to provide a ballast to make sure that the shaft 604 is in an upright position as it floats on the surface of a body of water.

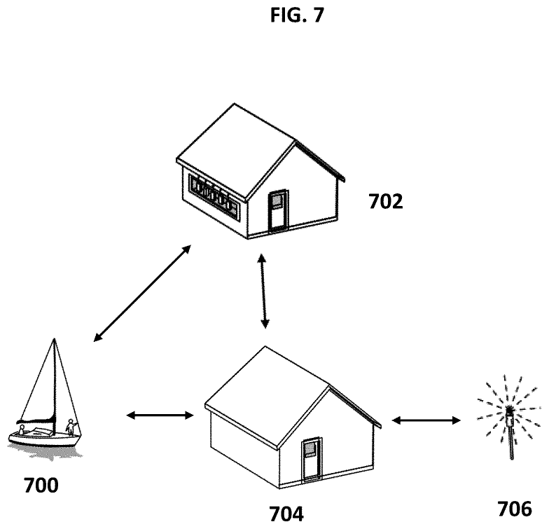

FIG. 7 is a flowchart of the mooring beacon reservation method. A user may access the reservation management interface application on a mobile platform 700 and wirelessly connect to the reservation management computer 702. In certain embodiments, the reservation management computer 702 may be housed in a different location than the mooring site 704. The reservation management computer 702 may communicate, via a wireless network, with a mooring database computer housed in the mooring site 704. The reservation management computer 702 may access the mooring database computer 704 to reserve a mooring beacon 706. After accessing the mooring database 704, the reservation management computer 702 can be configured to wirelessly connect to the selected mooring beacon 706 to reserve the mooring beacon 706. The user 700 may activate the light of the reserved mooring beacon 706 via an optical signal controller that may be built into the reservation management interface application 700. The optical signaling controller may allow the user to distinguish the reserved mooring beacon 706 from other surrounding mooring beacons.

1. A method of reserving a mooring beacon, comprising:
activating an application programming interface in communication with a database of mooring sites, wherein each mooring site comprises a plurality of mooring beacons;
transmitting a wireless signal from the application programming interface to a first mooring site within the database of mooring sites contained in a reservation management computer;
selecting the mooring beacon from the first mooring site, wherein the selected mooring beacon comprises a shaft that extends through a float and carries a receiver unit adapted to receive wireless signals;
receiving a location and availability of the selected mooring beacon from the reservation management computer;
reserving the selected mooring beacon for a desired reservation time and length of reservation, such that when the selected mooring beacon is reserved the database of mooring sites is updated to reflect the reserved mooring beacon as unavailable during the reservation time and length; and
initiating a signal from the reserved mooring beacon through the application programming interface while approaching the harbor.

2. The method of claim 1, wherein the step of initiating further comprises initiating an optical signaling device of the selected mooring beacon.

3. The method of claim 2, wherein the optical signaling device has a blinker function that can alternate colors and light patterns of the reserved mooring beacon, whereby the reserved mooring beacon is easily identifiable.

4. The method of claim 2, wherein the optical signaling device has a multi-color and omni-directional LED strobe light feature that can control a flash energy, a discharge time, and colors of the reserved mooring beacon.

5. The method of claim 1, further comprising sending a confirmation message to the application programming interface from the mooring site.

6. The method of claim 1, further comprising displaying a weather forecast on the application programming interface.

7. The method of claim 1, further comprising sending a warning message about hazardous weather conditions from the application programming interface.

8. The method of claim 1, wherein the mooring beacon has a GPS device and the application programming interface identifies a location of the mooring beacon.

9. The method of claim 1, wherein the application programming interface displays a status of the mooring beacons as available or unavailable.

10. The method of claim 1, wherein the wireless signal comprises a wireless communication selected from the group consisting of satellite, infrared, broadcast radio, radio, Wi-Fi, mobile, and Bluetooth.

11.-15. (canceled)

16. A mooring beacon reservation system, comprising:
a mobile platform containing an application programming interface;
a mooring site;
a reservation management computer containing a database of mooring beacons at the mooring site and connected to a wireless network, wherein the reservation management computer is in communication with the mobile platform containing the application programming interface via the wireless network;
the reservation management computer having a processor and a non-transitory computer-readable memory; and
the reservation management computer having a first transmitter that communicates with a first receiver of the mooring beacon to receive the mooring beacon's location and availability, such that the mooring beacon's location and availability is updated on the application programming interface and the database of mooring beacons, wherein the mooring beacon comprises a shaft that extends through a float and carries a receiver unit adapted to receive wireless signals.

17. The mooring beacon reservation system of claim 16, wherein the first transmitter and the first receiver are in near-field communication.

18. The mooring beacon reservation system of claim 16, wherein the mobile platform has a light intensity control function for the mooring beacons.

19. The mooring beacon reservation system of claim 16, wherein the mobile platform has a GPS system.

20. The mooring beacon reservation system of claim 16, wherein the mobile platform has a touchscreen display.
